(19) United States
(12) Patent Application Publication
(10) Pub. No.: US 2011/0061348 A1
(43) Pub. Date: Mar. 17, 2011

(54) Horse Halter

(76) Inventor: Alberto Sierra, Athol, ID (US)

(21) Appl. No.: 12/882,133

(22) Filed: Sep. 14, 2010

Related U.S. Application Data
(60) Provisional application No. 61/276,534, filed on Sep. 14, 2009.

(51) Int. Cl. B68B 1/02

(52) U.S. Cl. 54/24

(57) ABSTRACT

A horse halter that allows the handler a more effective means for training and controlling a horse by incorporating a novel method of applying pressure to the horse's neck in addition to applying pressure to the nose and poll regions of the horse as shown in traditional halters. The improved halter accomplishes this by incorporating a neck band which is coupled to the nose and poll bands such that when tension is exerted on the neck band via a lead line, pressure is simultaneously applied to the neck and nose regions of the horse and the head is pulled toward the horse's chest while pressure is released at the poll. After a horse has been conditioned using the neck band feature, the lead line may be disconnected from attachment to the neck band and secured solely to the nose and poll bands to function as a traditional halter.

### RELATED APPLICATION INFORMATION

This application claims priority to U.S. Provisional Patent Application Ser. No. 61/276,534, entitled “Sierra Horse Halter,” filed Sep. 14, 2009, which is incorporated herein by reference.

### BACKGROUND

The present invention relates to an improved horse halter. A halter is typically used to control a horse that is being trained, lead, or secured. Traditional horse halters are typically composed of straps or rope that attach to the head of the horse by wrapping around the nose and poll regions of the horse. When a traditional horse halter is connected to a lead line, pressure is exerted on the nose and poll region which allows the horse handler to effectuate some method of control over the movement of the horse's head. However, not all horses are responsive to pressure on the poll and a more effective means of controlling the horse was desired that did not depend primarily on the strength of horse handler when controlling or training an unruly horse. Accordingly, the present invention serves to overcome the shortcomings of a traditional horse halter by incorporating a more efficient and effective design.

### SUMMARY

The present invention allows the horse handler a more efficient and effective means of controlling a horse by adding a neck band in addition to the traditional horse halter which relies primarily upon the nose and poll bands to control the horse. When the improved halter is attached to a lead line via the neck band, pressure is exerted on the nose and neck regions of the horse and released at the poll as tension is applied to the lead line.

As shown in the attached drawings, the effect of simultaneous pressure at the neck and nose bands creates a “scissoring” motion whereby the nose of the horse is drawn to its chest as tension is exerted on the lead line. When the horse's head is drawn down towards its neck, the horse will have increased difficulty in resisting the handler's control such as by tossing its head or rearing back when the head is secured against the neck. In this fashion, the handler can discourage undesirable behavior utilizing less force than would be required using a traditional halter. After the horse has been appropriately conditioned using the neck band and nose bands in conjunction, the lead line may be disconnected from the neck band and connected to nose and poll bands via two central rings to function as a traditional halter.

Further objects and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

These and other features, aspects and advantages of the present invention will become better understood with regard to the following description, claims, and accompanying drawings where:

FIG. 1: Perspective view of the halter in the configuration it would normally conform to when mounted on a horse head.

FIG. 2: Perspective view of halter on horse head.

FIG. 3: Side view of the halter on a horse head with no tension exerted on the harness

FIG. 4: Side view of the halter on a horse head with tension exerted while the lead line is coupled to the neck band which pulls nose down towards the chest of the horse.

### DESCRIPTION

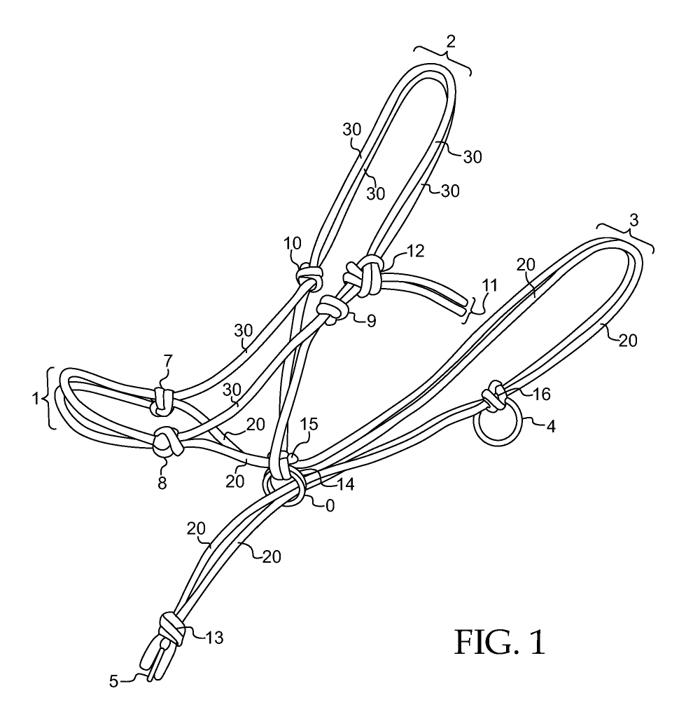

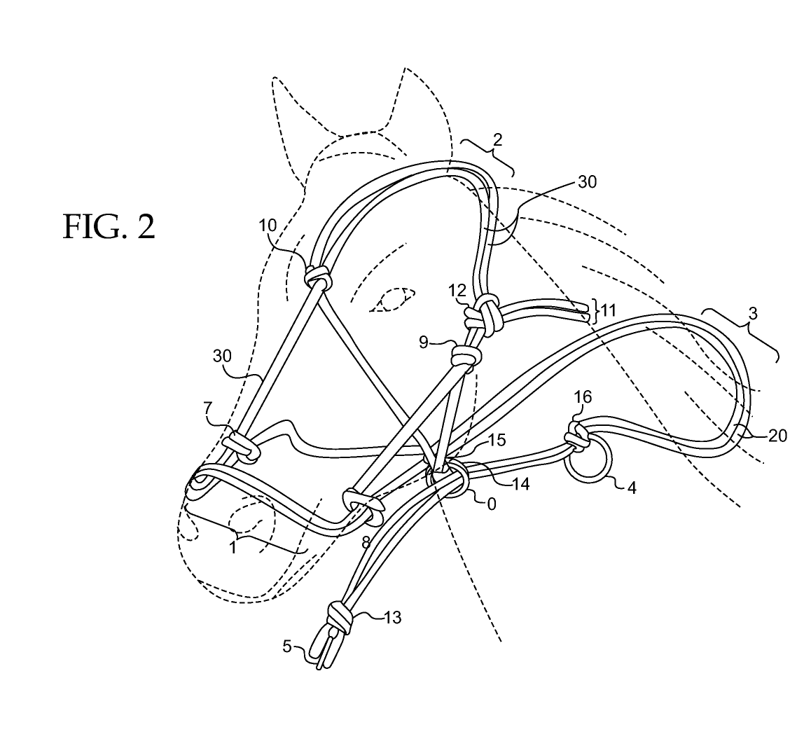

The present invention satisfies the need in the art for a horse halter that applies pressure on the nose and neck of the horse simultaneously to aid in controlling the horse rather than by applying pressure at the nose and poll regions alone as with a traditional halter. Generally speaking, the halter is capable of applying pressure to the horse in three regions: the nose band 1, poll band 2 or neck band 3. In a preferred embodiment of the halter, shown in FIGS. 1-4, the halter comprises two pieces of rope 20 and 30, eight knots, 7, 8, 9, 10, 12, 13, 15, 16, and four metal rings 0, 4, 5, 14. The ropes 20 and 30 used in the construction of the halter are composed of polyester and ⅜ of an inch in diameter. The four metal rings 0, 4, 5, 14, are solid brass and 1 ½ inches in diameter.

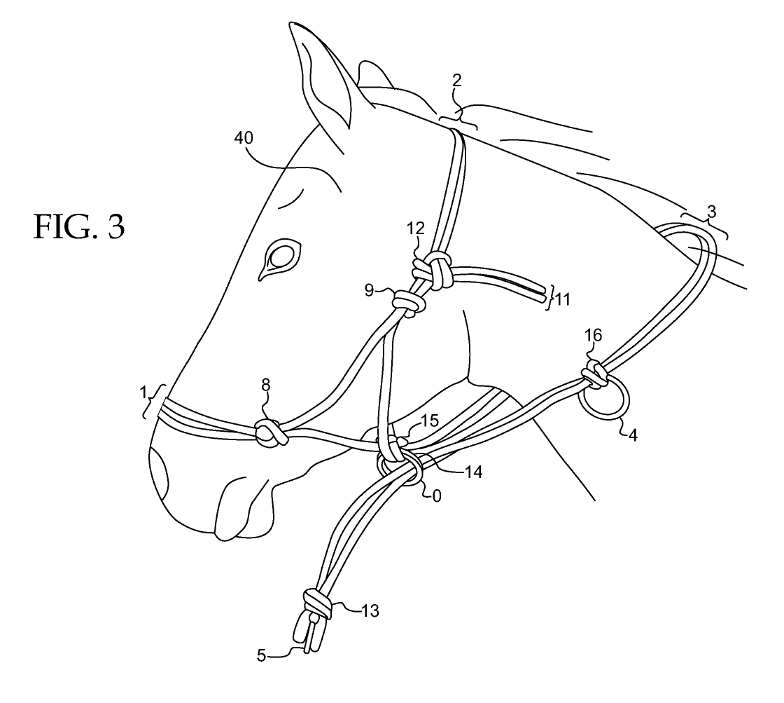

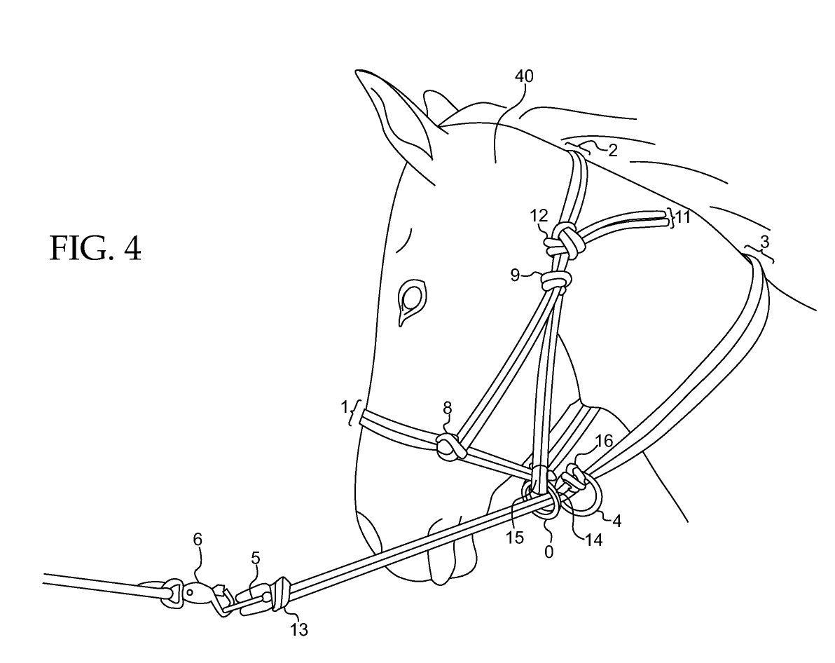

To create the halter, take the first piece of rope 20 and begin by making part of a knot 13 and bring the rope thru two central rings 0 and 14 and make part of a knot 16 and then loop over the neck of the horse 40 to then make part of a central knot 15 into which central rings 0 and 14 are secured. Then proceed to the far side of the halter and begin part of a knot 7 on the nose band 1 and then continues over the nose of the horse to begin part of a knot 8 on the nose band 1. The rope 20 then continues back down to complete central knot 15 and then passes back over the neck of the horse to complete a knot 16 to which a safety ring 4 is secured and then passes back to complete a knot 13 to which the neck pressure rope ring 5 is secured. The nose band 1 and neck band 3 are comprised of the first piece of rope 20 and refer to regions on the rope as shown in FIG. 1. As shown in FIG. 1, the nose band 1 transverses the horse's nose several inches above the horse's nostrils and the neck band 3 transverses the horse's neck approximately halfway down the horse's neck as shown in FIGS. 3-4.

The second piece of rope 30 begins at an area 11 located just below the horse's ear on the near side of the horse 40 and forms part of a knot 12 before passing over the poll and down the far side of the halter making part of a knot 10. The rope 30 then completes the nose band 1 knot 7 on the far side of the halter before passing over the nose of the horse and completing a nose band 1 knot 8 on the near side of the halter. The rope 30 then passes up to begin a knot 9 and loops back at a knot 12 to then complete a knot 9 and continue down through the central knot 15 and proceed back up to complete a knot 10 and continue back over the poll completing a knot 12. The poll band 2 is comprised entirely of the second piece of rope 30 as shown in FIG. 1 and transverses the horse 40 at the poll.

In operation as shown in FIG. 4, a lead line 6 is secured to the halter at a neck pressure rope ring 5. When tension is exerted on the lead line 6 as shown in FIG. 4, pressure is exerted on the horse at the nose band 1 and neck band 3 drawing the nose down towards the chest as tension is relieved from the poll band 2. As tension is exerted on the lead line 6 to the harness via the neck pressure rope ring 5, the safety ring 4 secured in a knot 16 is drawn no further than the two central rings 0 and 14 secured in a central knot 15 to aid in preventing injury to the horse. Additionally, the lead line may be attached to the two central rings 0 and 14 secured to a central knot 15 which will prevent pressure from being exerted on the neck band 3. It is expected that after a period of training the horse handler will be able to transfer the lead line 6 to the two central rings 0 and 14 secured to a central knot 15 after the horse is properly conditioned and attach the lead line 6 to the neck pressure rope ring 5 as needed.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the horse halter. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Also, any element in a claim that does not specifically state “means for” performing a function, should not be interpreted as a “means” or “step” clause as specified in 35 U.S.C. §112.

What is claimed is:

1. A horse halter comprising:
A horse halter in which a nose band is coupled to a neck band such that as tension is applied to the neck band, said tension is also transmitted and applied to the nose band whereby pressure is applied to the horse where said nose and neck bands contact the horse.

2. The horse halter apparatus of claim 1, further comprising a poll band coupled to said neck and nose bands.

3. The horse halter apparatus of claim 2 wherein said neck band transverses the neck of the horse substantially halfway down the length of the horse's neck.

4. The horse halter apparatus of claim 3 wherein said pressure is transferred from said neck band to the horse transversely to the neck of the horse.

5. The horse halter apparatus of claim 4 wherein said nose and neck bands are coupled via a central knot.

6. The horse halter apparatus of claim 5 wherein said poll band is coupled to said nose and neck bands via said central knot and two nose band knots (7,8).

7. The horse halter apparatus of claim 6 wherein said poll band transverses the poll area of the horse.

8. The horse halter apparatus of claim 7 wherein pressure is released on said poll band as pressure is increased on said neck and nose bands.

9. The horse halter apparatus of claim 8 wherein the apparatus is composed of rope.

10. A horse halter comprising:
a nose band; a poll band; a neck band; a central knot; nose band knots (7,8); wherein said nose, neck, and poll bands are coupled together at said central knot and said nose band and said poll band are coupled together at said nose band knots (7,8).

11. The horse halter of claim 10 further comprising two central rings (0,14); safety ring (4); neck pressure rope ring (5); wherein as tension is exerted thru said neck pressure rope ring (5) to said neck band, said safety ring (4) is pulled toward said central rings (0,14).

12. A method for controlling a horse comprising applying tension to the neck band which transmits tension to the nose band wherein pressure is applied to the horse where the neck and nose bands contact the horse.

13. The method of claim 12, wherein the horse's head is drawn towards its chest as pressure is applied at said neck and nose bands.

14. The method of claim 13 further comprising a poll band coupled to said nose and neck bands wherein pressure is released on the poll band as pressure is increased on said nose and neck bands.
